(19) United States
(12) Patent Application Publication
(10) Pub. No.: US 2025/0023353 A1
(43) Pub. Date: Jan. 16, 2025

(54) POWER DIFFERENCE COMPENSATION APPARATUS, POWER DIFFERENCE COMPENSATION METHOD, AND PROGRAM

(71) Applicant: NIPPON TELEGRAPH AND TELEPHONE CORPORATION, Tokyo (JP)

(72) Inventors: Motoki SUWABE, Tokyo (JP); Hiroya MINAMI, Tokyo (JP); Masaki KOZAI, Tokyo (JP); Toshihiro HAYASHI, Tokyo (JP)

(21) Appl. No.: 18/712,804

(22) PCT Filed: Dec. 14, 2021
(86) PCT No.: PCT/JP2021/046100

§ 371 Date: May 23, 2024

(51) Int. Cl. H02J 3/32

(52) U.S. Cl. CPC H02J 3/32

(57) ABSTRACT

A power difference compensation apparatus according to an embodiment is a power difference compensation apparatus that compensates for a difference between a power supply amount by renewable energy and a power demand amount of a load. The power difference compensation apparatus includes: a compensation pattern calculation unit configured to calculate, as a compensation pattern, a combination of a resource for compensating for a difference due to a long-term supply and demand variation in the difference and control content for the resource; and a long-term variation compensation unit configured to compensate for a difference due to the long-term supply and demand variation by controlling the resource based on the compensation pattern.

### TECHNICAL FIELD

The present invention relates to a power difference compensation apparatus, a power difference compensation method, and a program.

### BACKGROUND ART

In general, since a difference may occur between a power generation amount and a power demand amount, a structure for compensating for the difference is required. In particular, since a power generation amount by renewable energy depends on weather conditions or the like, this structure is very important for spread of renewable energy. As a technique of the related art, there has been proposed a technique in which a difference between a power generation amount by renewable energy and a demand amount is divided into a difference due to a short-term supply and demand variation and a difference due to a long-term supply and demand variation, and then the difference due to the short-term supply and demand variation is compensated for by a storage battery and the difference due to the long-term supply and demand variation is compensated for by a hydrogen storage system (for example, see Non-Patent Literature 1). In addition, there have been proposed many techniques for compensating for the difference due to the long-term demand variation. For example, techniques for compensating for the difference by a storage battery mounted in an electric vehicle (EV) are known.

### CITATION LIST

### Non-Patent Literature

Non-Patent Literature 1: Makoto Tsuda, Yoh Nagasaki, Daisuke Miyagi “Hybrid Energy Storage System Composed of Electric and Hydrogen Energy Storage Systems Suitable for Large-Capacity Emergency Power Supply and Effective Use of Renewable Energy”, Cryogenic Engineering 55 (1): 28-35, 2020.

### SUMMARY OF INVENTION

### Technical Problem

However, in techniques of the related art, a case where a difference due to a long-term supply and demand variation cannot be compensated for may occur.

For example, in the technique of the related art described in Non-Patent Literature 1, it is necessary to predict a remaining amount of a hydrogen storage system. However, if the prediction deviates, a situation where the difference cannot be compensated for may occur depending on a state of a storage facility. Similarly, for example, when compensation is executed by a storage battery mounted in an EV, it is necessary to predict the remaining amount of the storage battery, and when the prediction deviates, a situation where the difference cannot be compensated for may occur.

In this way, in the technique of the related art, it is necessary to predict remaining amounts of resources such as a hydrogen storage system and a storage battery that compensate for a difference due to a long-term demand variation. If the prediction deviates, a situation in which the difference cannot be compensated for may occur.

An embodiment of the present invention has been made in consideration of the foregoing circumstances and an object of the present invention is to achieve power difference compensation for renewable energy.

### Solution to Problem

To achieve the foregoing object, according to an embodiment, a power difference compensation apparatus that compensates for a difference between a power supply amount by renewable energy and a power demand amount of a load includes: a compensation pattern calculation unit configured to calculate, as a compensation pattern, a combination of a resource for compensating for a difference due to a long-term supply and demand variation in the difference and control content for the resource; and a long-term variation compensation unit configured to compensate for a difference due to the long-term supply and demand variation by controlling the resource based on the compensation pattern.

### Advantageous Effects of Invention

It is possible to achieve power difference compensation for renewable energy.

### BRIEF DESCRIPTION OF DRAWINGS

FIG. 1 is a diagram illustrating an example of an overall configuration of a power difference compensation system according to an embodiment.

FIG. 2 is a diagram illustrating an example of a hardware configuration of the power difference compensation apparatus according to the embodiment.

FIG. 3 is a diagram illustrating an example of a functional configuration of the power difference compensation apparatus according to the embodiment.

FIG. 4 is a flowchart illustrating an example of a flow of execution control processing of the power difference compensation processing according to the embodiment.

FIG. 5 is a flowchart illustrating an example of a flow of the power difference compensation processing according to the embodiment.

### DESCRIPTION OF EMBODIMENTS

Hereinafter, an embodiment of the present invention will be described. In the embodiment, a power difference compensation system 1 that can compensate for a difference between a power generation amount by renewable energy and a demand amount of the renewable energy (hereinafter referred to as a power difference) when a base such as a data center is a target will be described. Hereinafter, the base, which is the power difference compensation target, will be referred to as a “target base”. The power generation amount may be referred to as a “supply amount”, a “power supply amount”, or the like, and the demand amount may be referred to as a “power consumption amount”, a “power demand amount”, or the like.

Here, the power difference includes a difference due to a short-term supply and demand variation and a difference due to a long-term supply and demand variation. Hereinafter, compensation for a difference due to the short-term supply and demand variation is referred to as “short-term variation compensation” and compensation for a difference due to the long-term supply and demand variation is referred to as “long-term variation compensation”. In the power difference compensation system 1 according to the embodiment, the short-term variation compensation is achieved by charging and discharging of a storage battery, and the long-term variation compensation is achieved by movement of a load (for example, an information and communication technology (ICT) load such as a virtual machine (VM), a container, or the like) located in the target base, charging and discharging of the storage battery, utilization of a system power (also referred to as a commercial power), or the like. Accordingly, a storage facility or the like used for the long-term variation compensation is not required. For example, it is possible to prevent a situation in which the long-term variation compensation cannot be executed depending on a state of the storage facility.

### <Overall Configuration of Power Difference Compensation System 1>

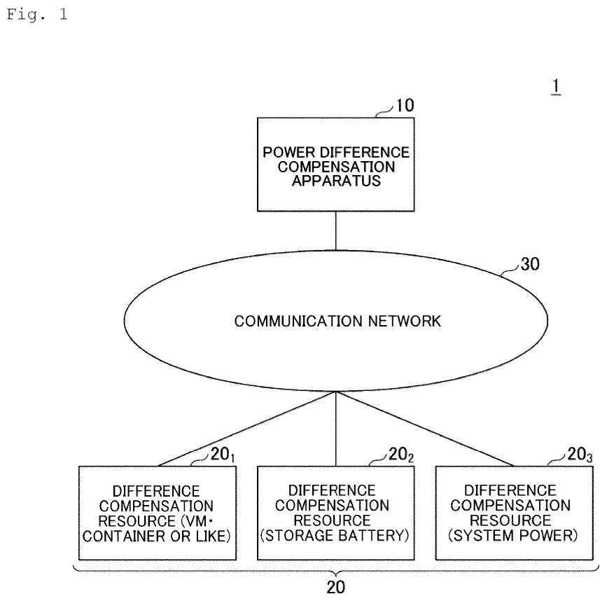

FIG. 1 is a diagram illustrating an example of an overall configuration of the power difference compensation system 1 according to the embodiment. As illustrated in FIG. 1, the power difference compensation system 1 according to the embodiment includes a power difference compensation apparatus 10 and a plurality of difference compensation resources 20. The power difference compensation apparatus 10 and each difference compensation resource 20 are communicably connected via any communication network 30. In the example illustrated in FIG. 1, the difference compensation resources 20 include a difference compensation resource 20₁ that is a VM or a container, a difference compensation resource 20₂ that is the storage battery, and a difference compensation resource 20₃ that is a system power.

The power difference compensation apparatus 10 is a computer or a computer system that achieves the short-term variation compensation and the long-term variation compensation. At this time, the power difference compensation apparatus 10 achieves the short-term variation compensation by charging and discharging of the storage battery (the difference compensation resource 20₂) and achieves the long-term variation compensation by movement of a load such as a VM or a container (the difference compensation resource 20₁), charging and discharging of the storage battery (the difference compensation resource 20₂), or utilization of the system power (the difference compensation resource 20₃).

The difference compensation resources 20 are various resources (loads or power supplies) used for power difference compensation. In FIG. 1, the difference compensation resource 20₁ that is a VM or a container on a physical machine installed at the target base, the difference compensation resource 20₂ that is the storage battery installed at the target base, and the difference compensation resource 20₃ that is a system power available at the target base are illustrated as the difference compensation resources 20. Here, these resources are exemplary and various other various loads or power supplies may be provided as the difference compensation resources 20.

The plurality of difference compensation resources 20 may be provided. In particular, there may be the plurality of difference compensation resources 20₁ because there are generally a plurality of VMs or containers. For example, when M is a total number of VMs and containers, there are difference compensation resources 20₁-1, . . . , 20₁-M. Similarly, when there are a plurality of storage batteries, there are the plurality of difference compensation resources 20₂. When a plurality of system powers can be used, there are the plurality of difference compensation resources 20₃.

### <Hardware Configuration of Power Difference Compensation Apparatus 10>

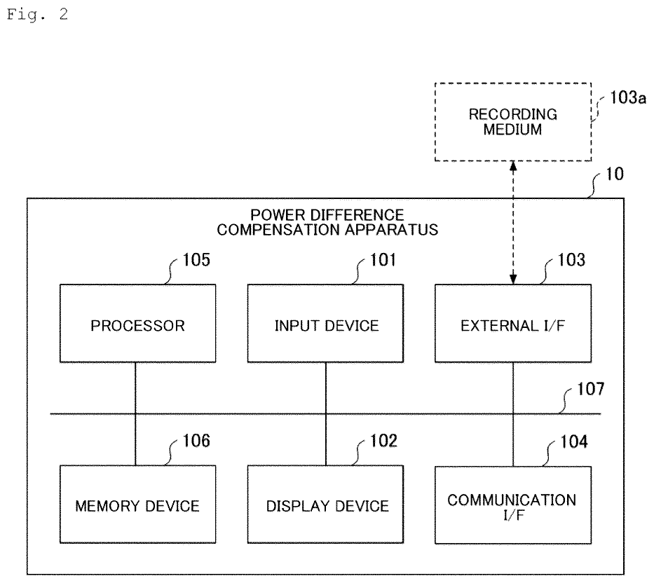

A hardware configuration example of the power difference compensation apparatus 10 according to the embodiment is illustrated in FIG. 2. As illustrated in FIG. 2, the power difference compensation apparatus 10 according to the embodiment includes an input device 101, a display device 102, an external I/F 103, a communication I/F 104, a processor 105, and a memory device 106. These pieces of hardware are connected to be able to communicate with each other via a bus 107.

The input device 101 is, for example, a keyboard, a mouse, a touchscreen, various physical buttons, or the like. The display device 102 is, for example, a display or a display panel. The power difference compensation apparatus 10 may not include at least one of the input device 101 or the display device 102.

The external I/F 103 is an interface with an external device such as a recording medium 103a. Examples of the recording medium 103a include a compact disc (CD), a digital versatile disk (DVD), a secure digital memory card (SD memory card), and a Universal Serial Bus (USB) memory card.

The communication I/F 104 is an interface for connecting the power difference compensation apparatus 10 to a communication network. Examples of the processor 105 include various arithmetic devices such as a central processing unit (CPU) and a graphics processing unit (GPU). Examples of the memory device 106 include various storage devices such as a hard disk drive (HDD), a solid state drive (SSD), a random access memory (RAM), a read only memory (ROM), and a flash memory.

The hardware configuration illustrated in FIG. 2 is merely exemplary. The power difference compensation apparatus 10 may have another hardware configuration. For example, the power difference compensation apparatus 10 may include the plurality of processors 105 or the plurality of memory devices 106 or various types of hardware other than the illustrated hardware.

### <Functional Configuration of Power Difference Compensation Apparatus 10>

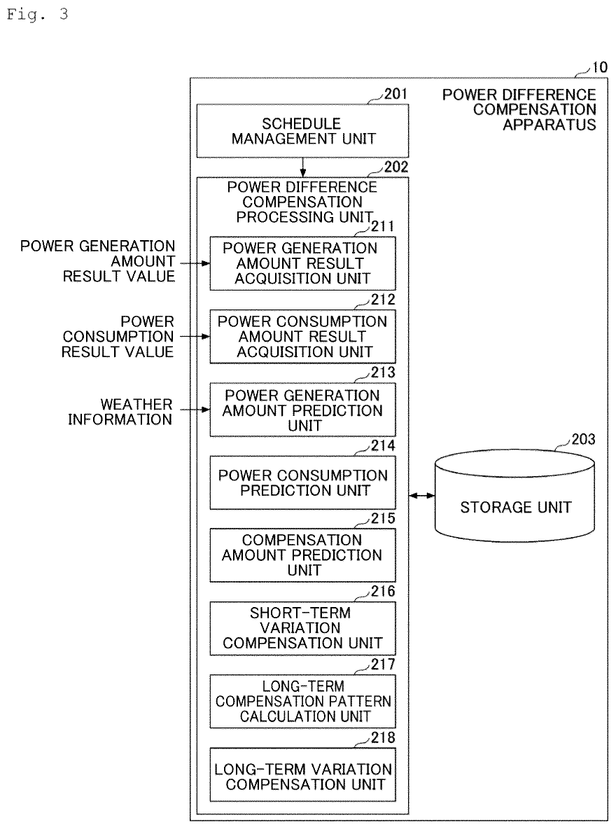

A functional configuration example of the power difference compensation apparatus 10 according to the embodiment is illustrated in FIG. 3. As illustrated in FIG. 3, the power difference compensation apparatus 10 according to the embodiment includes a schedule management unit 201 and a power difference compensation processing unit 202. Each of these units is implemented, for example, through processing performed by the processor 105 executing one or more programs installed in the power difference compensation apparatus 10. The power difference compensation apparatus 10 according to the embodiment includes a storage unit 203. The storage unit 203 is implemented by, for example, the memory device 106. However, the storage unit 203 may be implemented by, for example, a storage device (a database server or the like) connected to the power difference compensation apparatus 10 via the communication network 30.

The schedule management unit 201 controls execution of power difference compensation processing according to a predetermined schedule.

The power difference compensation processing unit 202 executes the power difference compensation processing for achieving the short-term variation compensation and the long-term variation compensation. Here, the power difference compensation processing unit 202 includes a power generation amount result acquisition unit 211, a power consumption amount result acquisition unit 212, a power generation amount prediction unit 213, a power consumption amount prediction unit 214, a compensation amount prediction unit 215, a short-term variation compensation unit 216, a long-term compensation pattern calculation unit 217, and a long-term variation compensation unit 218.

The power generation amount result acquisition unit 211 acquires a result value of a current power generation amount (that is, a current power supply amount to the target base) by the renewable energy. The power generation amount result acquisition unit 211 acquires, for example, a result value of the current power generation amount from power generation facilities using the renewable energy (hereinafter referred to as renewable energy power generation facilities) or a facility managing them, or the like. Hereinafter, it is assumed that a result value of a power generation amount of a renewable energy power generation facility i at time t is Pᵢ(t), and a total value of them with respect to i is P(t).

The power consumption amount result acquisition unit 212 acquires a result value of a current power consumption amount (that is, a current power demand amount at the target base) of a load (for example, the VM, the container, or the like located at the target base) that consumes the power amount. The power consumption amount result acquisition unit 212 may acquire result values of the current power consumption from, for example, load facilities and a facility managing them. Hereinafter, it is assumed that Qⱼ(t) is a result value of a power consumption of a load facility j at time t, and Q(t) is a total value of them with respect to j.

The power generation amount prediction unit 213 predicts a power generation amount of each renewable energy power generation facility i that supplies power to the target base by using weather information, and generates power generation amount prediction information from the prediction value.

Here, for example, when a current time is t=t₀, a prediction period is t=t₁, . . . , t_{N}, a prediction value of the power generation amount of the renewable energy power generation facility i at time t is pᵢ(t), and a total value of them with respect to i is p(t), the power generation amount prediction information is expressed as {p(t₁), . . . , p(t_{N})}. Here, t₀<t₁< . . . <t_{N}.

The weather information is a prediction value of information such as an amount of solar radiation or a wind speed for a certain future period at each predetermined point (or each region, or the like). For example, when an amount of solar radiation at the point (x,y) at time t is a(t, x, y), a wind speed is b(t, x, y), a period of a prediction target of the solar radiation and the wind speed is t=t₁, . . . , t_{N}, and a set of points of prediction targets is Z, weather information is expressed as {a(t, x, y), b(t, x, y)|t∈{t₁, . . . , t_{N}}, (x,y)∈Z}. However, the amount of the solar radiation and the wind speed are exemplary. In addition, for example, the weather information may include prediction values of information such as temperature and a flow rate of river or sea water. The power generation amount prediction unit 213 may acquire, for example, the weather information from an external weather system or the like. The power generation amount prediction unit 213 may construct a power generation amount prediction model in advance by a known technique (for example, a machine learning technique or the like) using, for example, past weather information and a result value of the power generation amount at that time and may predict a power generation amount of each renewable energy power generation facility i from the model and the currently acquired weather information to generate the power generation amount prediction information.

The power consumption amount prediction unit 214 generates power consumption amount prediction information, using past power consumption amount prediction information and a result value of the power consumption amount until the current time. Here, for example, the current time is t=t₀, the prediction period is t=t₁, . . . , t_{N}, a prediction value of the power consumption amount of the load facility j of the target base at time t is qⱼ(t), and a total value of them with respect to j is q(t), the power consumption amount prediction information is expressed as {q(t₁), . . . , q(t_{N})}. The power consumption amount prediction unit 214 may construct a power consumption prediction model by a known technique (for example, time-series prediction or the like) using, for example, past power consumption prediction information and a result value of the power consumption until the current time, and may predict the power consumption amount of each load facility j by the model to generate power consumption amount prediction information.

The compensation amount prediction unit 215 generates compensation amount prediction information, using the power generation amount prediction information generated by the power generation amount prediction unit 213 and the power consumption amount prediction information generated by the power consumption amount prediction unit 214. Here, for example, when the power generation amount prediction information is {p(t₁), . . . , p(t_{N})} and the power consumption amount prediction information is {q(t₁), . . . , q(t_{N})}, the compensation amount prediction information is expressed as {Δ(t₁), . . . , Δ(t_{N})}. Here, Δ(tᵢ):=p(tᵢ)−q(tᵢ) for i=1, . . . , N. Δ(tᵢ) is a power difference of the target base to be compensated at time t₁.

The short-term variation compensation unit 216 compensates for a power difference due to the short-term supply and demand variation among the power differences included in the power generation amount prediction information generated by the compensation amount prediction unit 215 by charging and discharging of the storage battery (the difference compensation resource 20₂). Here, the power difference due to the short-term demand variation is, for example, a power difference until about tens of seconds from the current time. For example, when Δt:=tᵢ₊₁−tᵢ is 1 second, a power difference from Δ(t₁) to Δ(t_{I}) (where I is about 10 to 19) is a power difference due to the short-term supply and demand variation. When Δ(t₁)>0, this indicates that a supply amount of power exceeds a demand amount, and short-term variation compensation is executed by charging the storage battery. Conversely, when Δ(t₁)<0, this indicates that the demand amount of power exceeds the supply amount, and short-term variation compensation is executed by discharging the storage battery.

For example, for an ultra-short-term power difference (for example, about 0 seconds to several seconds), there is a structure in which the power difference is mechanically and automatically compensated for by the storage battery (the difference compensation resource 20₂) as a known technique. Therefore, for the ultra-short-term difference compensation, the power difference may be compensated for by the structure.

The long-term compensation pattern calculation unit 217 calculates a compensation pattern for compensating for the power difference due to the long-term supply and demand variation among the power differences included in the power generation amount prediction information generated by the compensation amount prediction unit 215. Here, the power difference due to the long-term supply and demand variation is, for example, a power difference from about tens of minutes to one hour, excluding the power difference due to the short-term supply and demand variation. For example, when t_{N} is a time of about tens of minutes to one hour from the current time and a power difference from Δ(t₁) to Δ(t_{I}) is a power difference due to the short-term supply and demand variation, a power difference from Δ(t_{I+1}) to Δ(t_{N}) (or from Δ(t_{I+1}) to Δ(t_{N}′) for certain N′<N)) is a power difference due to the long-term supply and demand variation. The compensation pattern is a combination of one or more difference compensation resources 20 minimizing a predetermined cost function and its control content.

The long-term variation compensation unit 218 compensates for the power difference due to the long-term supply and demand variation by controlling the difference compensation resources 20 by the compensation pattern calculated by the long-term compensation pattern calculation unit 217.

The storage unit 203 stores various types of information. Examples of the information include information indicating a schedule used by the schedule management unit 201, the time-series data of the power generation amount result values {Pᵢ(t)} and {P(t)} acquired by the power generation amount result acquisition unit 211, the time-series data of the power consumption amount result values {Qᵢ(t)} and {Q(t)} acquired by the power consumption amount result acquisition unit 212, the power generation amount prediction information {p(t)} generated by the power generation amount prediction unit 213, the weather information, the power consumption amount prediction information {q(t)} generated by the power consumption amount prediction unit 214, and the compensation amount prediction information {Δ(t)} generated by the compensation amount prediction unit 215. In addition to the information, various types of information such as information indicating an interim calculation result may be stored.

### <Flow of Execution Control Processing of Power Difference Compensation Processing>

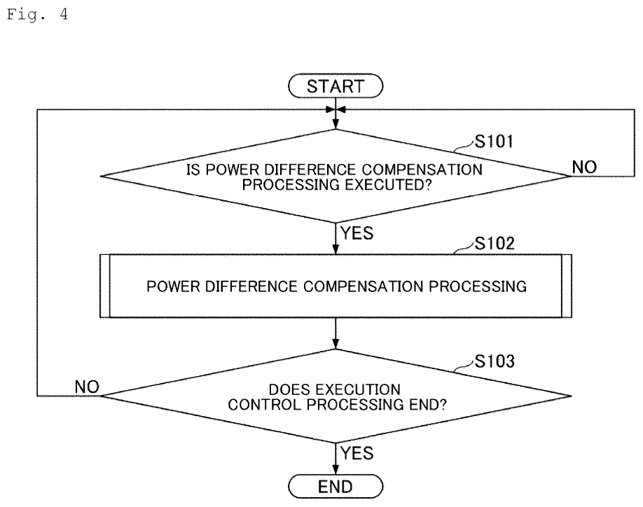

The execution control processing of the power difference compensation processing according to the embodiment will be described with reference to FIG. 4.

The schedule management unit 201 determines whether to execute the power difference compensation processing according to a predetermined schedule (step S101). Here, the schedule indicates a timing at which the power difference compensation processing is executed. For example, “a predetermined time has passed since the power difference compensation processing has been previously executed” or the like can be exemplified. In this case, the schedule management unit 201 determines that the power difference compensation processing is executed when the predetermined time has passed since the power difference compensation processing has been previously executed. Otherwise, it is determined that the power difference compensation processing is not executed. The schedule may be, for example, “a predetermined date and time has arrived” may be used in addition to “a predetermined time has passed since the power difference compensation processing has been previously executed”.

When it is determined that the power difference compensation processing is executed in the foregoing step S102, the schedule management unit 201 requests the power difference compensation processing unit 202 to execute the power difference compensation processing (step S102). Accordingly, the power difference compensation processing is executed by the power difference compensation processing unit 202. Details of the power difference compensation processing will be described below.

When it is determined in the foregoing step S102 that the power difference compensation processing is not executed, the schedule management unit 201 enters a waiting state until a timing at which the power difference compensation processing is executed is reached.

The schedule management unit 201 determines whether the execution control processing of the power difference compensation processing ends (step S103). Here, examples of the case where it is determined that the execution control processing of the power difference compensation processing ends include a case where the execution control processing temporarily ends by maintenance or the like of the power difference compensation apparatus 10.

When it is determined in the foregoing step S103 that the execution control processing of the power difference compensation processing does not end, the schedule management unit 201 returns to step S101. Accordingly, the power difference compensation processing is repeatedly executed in accordance with the schedule.

### <Flow of Power Difference Compensation Processing>

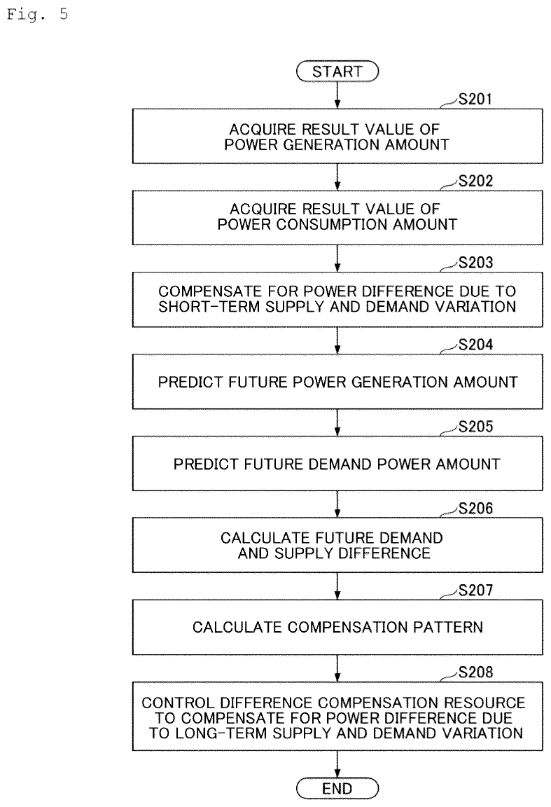

Next, the power difference compensation processing according to the embodiment will be described with reference to FIG. 5.

The power generation amount result acquisition unit 211 of the power difference compensation processing unit 202 acquires Pᵢ(t) and P(t) at the current time t=t₀ (step S201). The power generation amount result acquisition unit 211 may acquire only P(t).

The power consumption amount result acquisition unit 212 of the power difference compensation processing unit 202 acquires the power consumption amount result value Qⱼ(t) and Q(t) at the current time t=t₀ (step S202). The power consumption amount result acquisition unit 212 may acquire only Q(t).

The short-term variation compensation unit 216 of the power difference compensation processing unit 202 compensates for the power difference due to the short-term supply and demand variation among the compensation amount prediction information {Δ(t)} generated in the previous power difference compensation processing by charging and discharging of the storage battery (the difference compensation resource 20₂) (step S203).

The power generation amount prediction unit 213 of the power difference compensation processing unit 202 predicts a power generation amount of each renewable energy power generation facility i supplying power to the target base using the weather information, and generates the power generation amount prediction information {p(t); t=t₁, . . . , t_{N}} (where t₀<t₁< . . . <t_{N}, [t₁,t_{N}] is a prediction period) (step S204). The power generation amount prediction unit 213 may acquire latest weather information at the current time t=t₀, and then may generate the power generation amount prediction information {p(t); t=t₁, . . . , t_{N}} using the weather information.

The power consumption amount prediction unit 214 of the power difference compensation processing unit 202 generates the power consumption amount prediction information {q(t); t=t₁, . . . , t_{N}} using the power consumption amount prediction information {q(t):t∈T} generated in the previous power difference compensation processing and the power consumption amount result value {Q(t)∈T} until the current time (step S205). Here, T is a period used to generate the power consumption amount prediction information and is expressed as T=[t₀−ΔT, t₀] or the like using a predetermined time width ΔT.

The compensation amount prediction unit 215 of the power difference compensation processing unit 202 generates the compensation amount prediction information {Δ(t); t=t₁, . . . , t_{N}} using the power generation amount prediction information {p(t); t=t₁, . . . , t_{N}} generated in the foregoing step S204 and the power consumption amount prediction information {q(t); t=t₁, . . . , t_{N}} generated in the foregoing step S205 (step S206). Here, Δ(t₁):=p(tᵢ)−q(tᵢ) represents a power difference (a supply and demand difference) of the target base to be compensated at the time tᵢ.

The long-term compensation pattern calculation unit 217 of the power difference compensation processing unit 202 calculates the compensation pattern for compensating for the power difference due to the long-term supply and demand variation among the power differences included in the power generation amount prediction information {Δ(t); t=t₁, . . . , t_{N}} generated in the foregoing step S206 (step S207). Here, the long-term compensation pattern calculation unit 217 calculates a combination of one or more difference compensation resources 20 minimizing a value of a predetermined cost function and its control content as the compensation pattern. As the control content of the difference compensation resource 20₁ (the VM or the container), there is “movement of the difference compensation resource 20₁” or the like. The control content of the difference compensation resource 20₂ (the storage battery) include “charging” and “discharging”. The control content of the difference compensation resource 20₃ (the system power) includes “power purchasing” and “power selling”.

For example, when C₁ is a cost required for moving the load (the VM or the container) located in the target base to another base, C₂ is a cost required for charging or discharging the storage battery, and C₃ is a cost required for using the system power, the long-term compensation pattern calculation unit 217 calculates a compensation pattern with which long-term variation compensation can be achieved, and that minimizes a cost function C=C(C₁, C₂, C₃).

Specifically, for example, it is assumed that the power difference {Δ(t)} due to the long-term demand and supply variation is Δ(t)<0 with respect to each time t (or many of the times t). In this case, since the long-term demand amount exceeds the supply amount, it is necessary to move one or more difference compensation resources 20₁ (the VMs or the containers) to another base to reduce the load, discharge the difference compensation resources 20₂ (the storage battery), and purchase power from the difference compensation resources 20₃ (the system power). Therefore, a combination of the difference compensation resources 20, in which the value of the cost function C determined from the required costs C₁, C₂, and C₃ is the smallest, is calculated as the compensation pattern. There may be a compensation pattern in which, as a result of the movement of the one or more difference compensation resources 20₁ (the VMs or the containers) to another base, surplus power is generated and the difference compensation resource 20₂ (the storage battery) is charged.

Conversely, for example, it is assumed that the power difference {Δ(t)} due to the long-term supply and demand variation is Δ(t)>0 with respect to each time t (or many of the times t). In this case, since the long-term supply amount exceeds the demand amount, the difference compensation resource 20₂ (the storage battery) may basically be charged. The VM or the container may be moved from the other base to the target base, or the surplus power may be sold to the system power. Therefore, a combination of the difference compensation resources 20, in which the value of the cost function C determined from the required costs C₁, C₂, and C₃ is the smallest, may be calculated as the compensation pattern.

Although various functions can be considered as the cost function C=C(C₁, C₂, C₃), for example, C(C₁, C₂, C₃)=C₁+C₂+C₃. In addition, for example, C (C₁, C₂, C₃)=αC₁+βC₂+γC₃ (where 0<α, β, γ≤1).

Here, although various items are considered as items for calculating the cost C₁, for example, one or more of items such as a change amount of communication quality associated with the movement of the load, a required time associated with the movement of the load, an amount of power compensated for in association with the movement of the load, and an influence on service level agreement (SLA) can be exemplified. Similarly, various items for calculating the cost C₂ can be considered. However, for example, one or more of items such as deterioration in battery performance associated with an increase of the number of times charging or discharging is performed, a discharge amount used for compensation, and a charge amount at which the storage battery is charged by compensation can be exemplified. Similarly, various items for calculating the cost C₃ can be considered. However, for example, one or more of items such as a fee when power is purchased from a system power, a fee when power is sold to a system power, and the degree of deterioration in a utilization rate of the renewable energy.

The values of the foregoing items when each cost is calculated may be converted into any index values or evaluation values, and a sum, a product, or the like of the index values or the evaluation values may be calculated as a cost. At this time, the index values or evaluation values may be normalized, such as scale alignment, as necessary.

Various index values or evaluation values can be considered. However, for example, the following (1) to (4) can be exemplified.

### (1) Power Generation Cost

A value of each item related to the cost Cᵢ (where i=1, 2, 3) is converted into an amount of money, and a sum of the amounts of money is defined as the cost Cᵢ. In this case, a compensation pattern with the lowest power generation cost is calculated.

### (2) CO2 Emission Amount

A value of each item related to the cost Cᵢ (i=1, 2, 3) is converted into a CO2 emission amount, and a sum of the CO2 emission amounts is defined as the cost Cᵢ. In this case, a compensation pattern with the smallest CO2 emission amount is calculated.

### (3) Utilization Rate of Renewable Energy

A value of each item related to the cost Cᵢ (i=1, 2, 3) is converted into a value representing an influence on an increase in the utilization rate of the renewable energy, and a sum of the values is defined as the cost Cᵢ. In this case, a compensation pattern with the smallest influence on the increase in the utilization rate of the renewable energy is calculated.

### (4) Service Stability

For the cost C₁, the value of each item is converted into a value (for example, an amount of money or the like) representing an influence on service quality or the like, and a sum of the values is defined as the cost C₁. In this case, a compensation pattern with a small service influence can be calculated.

Naturally, the foregoing (1) to (4) are exemplary, and the index values or the evaluation values are not limited to these values. For example, it is possible to calculate an index value or an evaluation value obtained by appropriately combining a plurality of index values or evaluation values, or calculate a weighted sum of the plurality of index values or evaluation values as the index value or the evaluation value.

After step S207, the long-term variation compensation unit 218 of the power difference compensation processing unit 202 controls the difference compensation resources 20 in accordance with the control content based on the difference compensation resources 20 and its control content included in the compensation pattern calculated in the foregoing step S207 (step S208). Accordingly, the long-term variation compensation is achieved.

For example, when the compensation pattern indicates that two VMs are moved to another base A, the long-term variation compensation unit 218 executes control such that the two VMs (for example, the difference compensation resources 20₁-1 and 20₁-2) to the base A. The base of the movement destination of the VMs may be determined in advance or designated as the control content, or may be determined by any standard (for example, a base with a lowest power demand or a base of the smallest number of VMs or containers may be determined as the movement destination).

As another example, when the compensation pattern indicates that two VMs are moved to another base A and the system power is purchased by a certain amount of power after 30 minutes, the long-term variation compensation unit 218 executes control such that the two VMs (for example, the difference compensation resources 20₁-1 and 20₁-2) are moved to the base A and executes control such that the amount of power is purchased from the system power (the difference compensation resource 20₃) after 30 minutes.

### Conclusion

As described above, with respect to the difference between the power generation amount by the renewable energy and the demand amount, the power difference compensation system 1 according to the embodiment can compensate for the difference due to the short-term supply and demand variation and the difference due to the long-term supply and demand variation. In addition, with respect to the difference due to the long-term supply and demand variation, the power difference compensation system 1 according to the embodiment executes the compensation by moving the ICT load such as the VM or the container to control the demand amount of the power of the ICT load. Therefore, a facility (for example, a hydrogen storage system as described in Non-Patent Literature 1) compensating a difference due to a long-term supply and demand variation is not required. For example, it is possible to prevent a situation where long-term variation compensation cannot be executed depending on a state of the facility.

The present invention is not limited to the specifically disclosed embodiments, and various modifications, changes, combinations with known techniques, and the like can be made without departing from the scope of the claims.

### REFERENCE SIGNS LIST

10 Power difference compensation apparatus
20 Difference compensation resource
30 Communication network
101 Input device
102 Display device
103 External I/F
103a Recording medium
104 Communication I/F
105 Processor
106 Memory device
107 Bus
201 Schedule management unit
202 Power difference compensation processing unit
203 Storage unit
211 Power generation amount result acquisition unit
212 Power consumption amount result acquisition unit
213 Power generation amount prediction unit
214 Power consumption amount prediction unit
215 Compensation amount prediction unit
216 Short-term variation compensation unit
217 Long-term compensation pattern calculation unit
218 Long-term variation compensation unit

1. A power difference compensation apparatus that compensates for a difference between a power supply amount by renewable energy and a power demand amount of a load, comprising:
a processor; and
a memory storing program instructions that cause the processor to:
calculate, as a compensation pattern, a combination of (i) a resource for compensating for a difference due to a long-term supply and demand variation in the difference and (ii) control content for the resource; and
compensate for a difference due to the long-term supply and demand variation by controlling the resource based on the compensation pattern.

2. The power difference compensation apparatus according to claim 1, wherein the resource includes the load, and control content for the load includes movement of the load.

3. The power difference compensation apparatus according to claim 1, wherein the resource includes an ICT load that is the load, and control content for the load includes movement of the ICT load.

4. The power difference compensation apparatus according to claim 1, wherein the program instructions cause the processor to calculate the compensation pattern that minimizes a cost function value determined by a predetermined cost for the resource and the control content for the resource.

5. The power difference compensation apparatus according to claim 4, wherein the resource further includes a storage battery and system power, control content for the storage battery is charging or discharging of power, and control content for the system power is purchasing or selling of power.

6. The power difference compensation apparatus according to claim 5,
wherein a cost for movement of the load is determined from at least one or more items of a change amount of communication quality associated with the movement of the load, a required time associated with the movement of the load, an amount of power compensated for in association with the movement of the load, or an influence on SLA associated with the movement of the load,
wherein a cost for the charging or the discharging of the storage battery is determined from at least one or more items of deterioration in battery performance associated with an increase in the number of times the charging or the discharging of the storage battery is performed or the amount of power of the charging or the discharging, and
wherein a cost for purchasing or selling of the system power is determined from at least one or more items of a fee when purchasing of power from the system power or selling of power to the system power, or a degree of deterioration in a utilization rate of the renewable energy.

7. The power difference compensation apparatus according to claim 4, wherein the cost function value indicates one of a power generation cost, a CO2 emission amount, a utilization rate of the renewable energy, or stability of a service provided by the load.

8. A power difference compensation method comprising:
calculating, as a compensation pattern, a combination of (i) a resource for compensating for a difference due to a long-term supply and demand variation in the difference and (ii) control content for the resource; and
compensating for a difference due to the long-term supply and demand variation by controlling the resource based on the compensation pattern.

9. A non-transitory computer-readable recording medium having stored therein a program causing a computer to perform a process comprising:
calculating, as a compensation pattern, a combination of (i) a resource for compensating for a difference due to a long-term supply and demand variation in the difference and (ii) control content for the resource; and
compensating for a difference due to the long-term supply and demand variation by controlling the resource based on the compensation pattern.
